(19) United States
(12) Patent Application Publication
(10) Pub. No.: US 2010/0111533 A1
(43) Pub. Date: May 6, 2010

(54) WDM PON SYSTEM

(75) Inventors: Douglas BECKETT, Kanata (CA); Rong CHEN, Ottawa (CA); Bin CAO, Kanata (CA)

Correspondence Address: KED & ASSOCIATES, LLP, P.O. Box 221200, Chantilly, VA, 20153-1200, US

(73) Assignee: NORTEL NETWORKS LIMITED, St. Laurent (CA)

(21) Appl. No.: 12/533,028

(22) Filed: Jul. 31, 2009

Related U.S. Application Data
(60) Provisional application No. 61/111,757, filed on Nov. 6, 2008.

(51) Int. Cl. H04J 14/00

(52) U.S. Cl. 398/68

(57) ABSTRACT

A Wavelength Division Multiplexed Passive Optical Network (WDM-PON) includes: a respective Optical Network Terminal (ONT) at each one of a plurality of customer sites, each ONT comprising an ONT Fabry Perot (F-P) laser for generating a respective broadband multi-mode uplink optical signal; and an Array Waveguide Grating (AWG) for receiving each broadband multi-mode uplink optical signal through a respective branch port, and for multiplexing a portion of each received broadband multi-mode uplink optical signal into a Wavelength Division Multiplexed (WDM) signal. Each ONT F-P laser is non-injection locked. A gain of each ONT F-P laser is sufficiently inhomogeneous that the modes of the respective broadband multi-mode uplink optical signal are independent. A filter function of the AWG includes a pass band that encompasses at least one mode of a broadband multi-mode uplink optical signal.

### CROSS-REFERENCE TO RELATED APPLICATIONS

This application is based on, and claims benefit of U.S. Provisional Patent Application Ser. No. 61/111,757 filed Nov. 6, 2008.

### FIELD OF THE INVENTION

The present application relates generally to Wavelength Division Multiplexed Passive Optical Networks (WDM PON) and, more specifically, to a WDM PON System With Distribution Via Cyclic Array Waveguide Grating.

### BACKGROUND OF THE INVENTION

A passive optical network (PON) is a point-to-multipoint network architecture in which unpowered optical splitters are used to enable a single optical fibre to serve multiple premises. A PON typically includes an Optical Line Terminal (OLT) at the service provider's central office connected to a number (typically 32-128) of Optical Network Terminals (ONTs), each of which provides an interface to customer equipment.

In operation, downstream signals are broadcast from the OLT to the ONTs on a shared fibre network. Various techniques, such as encryption, can be used to ensure that each ONT can only receive signals that are addressed to it. Upstream signals are transmitted from each ONT to the OLT, using a multiple access protocol, such as time division multiple access (TDMA), to prevent “collisions”.

A Wavelength Division Multiplexing PON, or WDM-PON, is a type of passive optical network in which multiple optical wavelengths are used to increase the upstream and/or downstream bandwidth available to end users. FIG. 1 is a block diagram illustrating a typical WDM-PON system. As may be seen in FIG. 1, the OLT 4 comprises a plurality of transceivers 6, each of which includes a light source 8 and a receiver 10 for sending and receiving optical signals on respective wavelength channels, and an optical combiner/splitter 12 for combining light from/to the light source 8 and receiver 10 onto a single optical fibre 14. The light source 8 may be a conventional laser diode such as, for example, a distributed feed-back (DFB) laser, for transmitting data on the desired wavelength using either direct laser modulation, or an external modulator (not shown) as desired. The receiver 10 may, for example, comprise a PIN diode for detecting optical signal received through the network. An optical mux/demux 16 (such as, for example, a Thin-Film Filter (TFF) or an Array Waveguide Grating (AWG)) is used to couple light between each transceiver 6 and an optical fibre trunk 18, which may include one or more passive optical power splitters (not shown).

A passive remote node 20 serving one or more customer sites includes an optical mux/demux 22 for demultiplexing wavelength channels (λ1 . . . λn) from the optical trunk fibre 18. Each wavelength channel is then routed to an appropriate branch port 24 which supports a respective WDM-PON branch 26 comprising one or more Optical Network Terminals (ONTs) 28 at respective customer premises. Typically, each ONT 28 includes a light source 30, detector 32 and combiner/splitter 34, all of which are typically configured and operate in a manner mirroring that of the corresponding transceiver 6 in the OLT 4.

Typically, the wavelength channels (λ1 . . . λn) of the WDM-PON are divided into respective channel groups, or bands, each of which is designated for signalling in a given direction. For example, C-band (e.g. 1530-1565 nm) channels may be allocated to uplink signals transmitted from each ONT 28 to the OLT 4, while L-band (e.g. 1565-1625 nm) channels may be allocated to downlink signals from the OLT 4 to the ONT(s) 26 on each branch 26. In such cases, the respective optical combiner/splitters 12, 34 in the OLT transceivers 6 and ONTs 28 are commonly provided as passive optical filters well known in the art.

The WDM-PON illustrated in FIG. 1 is known, for example, from “Low Cost WDM PON With Colorless Bidirectional Transceivers”, Shin, D J et al, Journal of Lightwave Technology, Vol. 24, No. 1, January 2006. With this arrangement, each branch 26 is allocated a predetermined pair of wavelength channels, comprising an L-band channel for downlink signals transmitted from the OLT 4 to the branch 26, and a C-band channel for uplink signals transmitted from the ONT(s) 28 of the branch 26 to the OLT 4. The MUX/DEMUX 16 in the OLT 4 couples the selected channels of each branch 26 to a respective one of the transceivers 6. Consequently, each transceiver 6 of the ONT is associated with one of the branches 26, and controls uplink and downlink signalling between the ONT 4 and the ONT(s) 28 of that branch 26. Each transceiver 6 and ONT 28 is rendered “colorless”, by using reflective light sources 8, 30, such as reflective semi-conductor optical amplifiers; injection-locked Fabry-Perot lasers; reflective electro-absorptive modulators; and reflective Mach-Zehnder modulators. With this arrangement, each light source 8, 30 requires a “seed” light which is used to produce the respective downlink/uplink optical signals. In the system of FIG. 1, the seed light for downlink signals is provided by an L-band seed light source (SLS) 36 via an L-band optical circulator 38. Similarly, the seed light for uplink signals is provided by a C-band seed light source (SLS) 40 via a C-band optical circulator 42.

A limitation of the system of FIG. 1 is that signal reach is dependent on the optical power of the seed light that is injected into each light source 8, 30, and the modulated power that can be derived from that seed light by each light source. This issue is particularly important in the up-link direction, because the C-band seed light must be transmitted from the OLT 4 to each ONT 26, injected into each light source 30, and the resulting modulated uplink signals must then traverse the WDM-PON to the transceivers 6 in the OLT 4. The noise and signal attenuation associated with traversing the WDM-PON twice imposes significant limitations in the signal reach and bandwidth of the uplink signals.

A further limitation of this system is that the bandwidth of the light generated by reflective light sources seeded with a spectrally-sliced broadband seed light source tends to be broad. This means that, as data rates rise above about 1 Gb/s, dispersion penalties can significantly degrade system performance.

A further limitation of this system is that the use of spectral slicing of the BLS 36, 40 imposes a noise-related bit-error-rate floor that increases proportionally with decreasing channel-width. This noise-related floor limits both data transmission rate and the maximum channel-count by preventing more, narrower, channels within a band.

### SUMMARY OF THE INVENTION

An aspect of the present invention provides a Wavelength Division Multiplexed Passive Optical Network (WDM-PON) including: a respective Optical Network Terminal (ONT) at each one of a plurality of customer sites, each ONT comprising an ONT Fabry Perot (F-P) laser for generating a respective broadband multi-mode uplink optical signal; and an Array Waveguide Grating (AWG) for receiving each broadband multi-mode uplink optical signal through a respective branch port, and for multiplexing a portion of each received broadband multi-mode uplink optical signal into a Wavelength Division Multiplexed (EDFM) signal. Each ONT F-P laser is non-injection locked. A gain of each ONT F-P laser is sufficiently inhomogeneous that the modes of the respective broadband multi-mode uplink optical signal are independent. A filter function of the AWG includes a pass band that encompasses at least one mode of a broadband multi-mode uplink optical signal.

### BRIEF DESCRIPTION OF THE DRAWINGS

Further features and advantages of the present invention will become apparent from the following detailed description, taken in combination with the appended drawings, in which:

FIG. 1 schematically illustrates a conventional WDM-PON known in the prior art;

FIG. 2 illustrates an output spectrum of a non-injection-locked Fabry-Perot laser;

FIG. 3 schematically illustrates a representative embodiment of the present invention; and

FIG. 4 schematically illustrates a WDM-PON implementing the embodiment of FIG. 3.

It will be noted that throughout the appended drawings, like features are identified by like reference numerals.

### DETAILED DESCRIPTION OF PREFERRED EMBODIMENTS

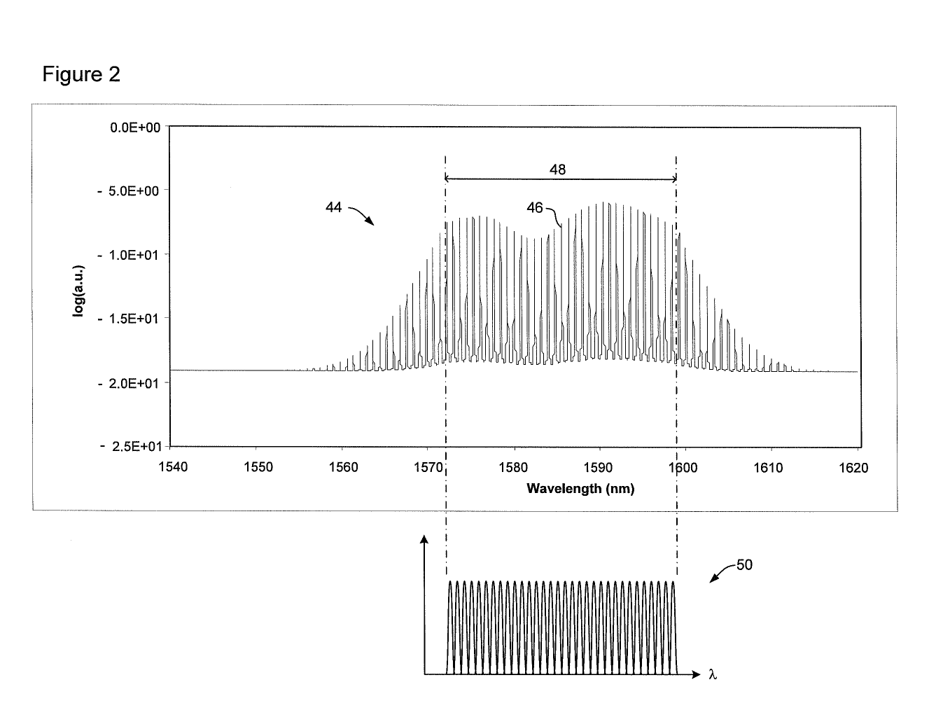

The present invention provides techniques for enabling low-cost high performance WDM-PON operation with increased signal reach as compared to conventional systems. A representative embodiment is described below with reference to FIGS. 2-5.

In very general terms, the present invention exploits the characteristics of AWGs and non-injection locked F-P lasers to facilitate low-cost high performance WDM-PON operation with increased signal reach as compared to conventional systems.

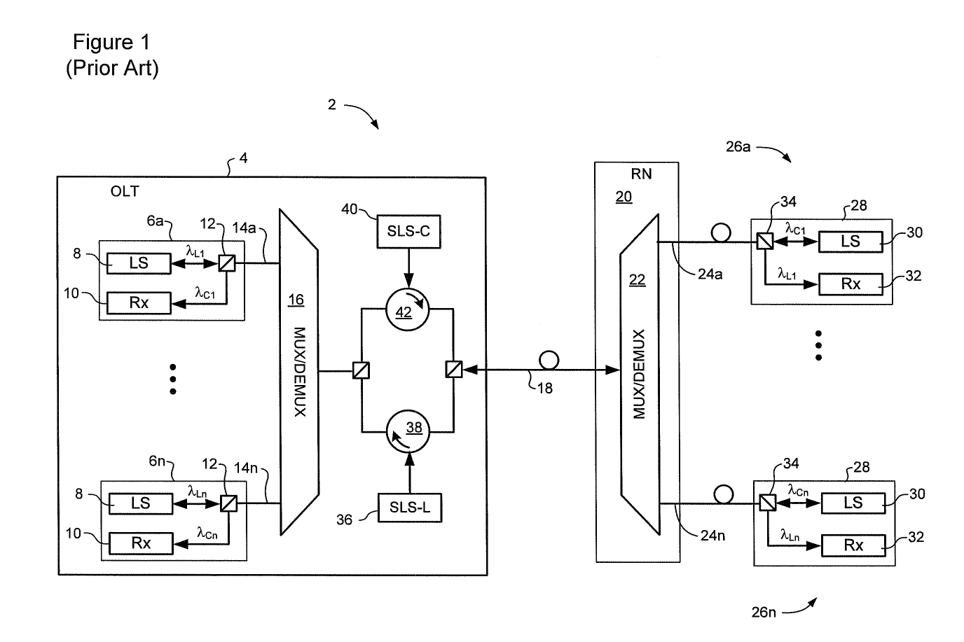

As is also known in the art, an injection-locked Fabry-Perot (F-P) laser produces an output light that is frequency-locked to the frequency of the seed light injected into the F-P laser. In conventional WDM-PON systems of the type described above with reference to FIG. 1, this characteristic is used to generate uplink signals that are centered at desired wavelengths. Thus, the C-band seed light source (SLS) 40 (see FIG. 1) generates a “comb” of narrow-band continuous seed lights, each centered at a desired uplink channel wavelength. The MUX 22 couples each seed light into a respective one of the branch ports 24, so that each ONT 28 receives one of the seed lights. At each ONT 28, the seed light is injected into the light source 30, which outputs an uplink signal that is frequency-locked with the injected seed light and modulated with data received from customer premise equipment (not shown).

In the absence of an injected seed light, an F-P laser will output a multi-mode optical signal having a broad optical spectrum. FIG. 2 illustrates a typical spectrum of an F-P laser without seed light injection. As may be seen in FIG. 2, the non-injection seeded F-P laser output spectrum 44 is not continuous, but rather is composed of a plurality of narrow “spikes” (or modes) 46 at a spacing that is determined by the design and construction of the laser. The strongest modes 46 are concentrated within a band 48 having a width that is also determined by the construction of the laser. Thus, for example, the laser can be constructed such that the band 48 corresponds with a channel band 50 (e.g. either the C-band or L-Band) of a WDM-PON. Modern semiconductor lasers and Quantum Dot lasers can be constructed to exhibit desired output band width and mode spacing parameters, and have a sufficiently inhomogeneous gain that the modes 46 are effectively independent of one another.

As is known in the art, an Array-Waveguide Grating (AWG) is capable of demultiplexing a plurality of wavelength channels from Wavelength Division Multiplexed (WDM) signal received through a WDM fibre, and outputting each demultiplexed wavelength channel though a respective one of a plurality of branch fibres. Within the free spectral range (FSR) of the AWG, the AWG implements a filter function characterised by a respective pass-band centered at each channel wavelength of the WDM-PON. Each pass-band is associated with a respective branch fiber, so that light of a given WDM PON channel is coupled between the WDM fiber and the associated branch fibre, while out-or-band (for that branch fibre) noise is suppressed.

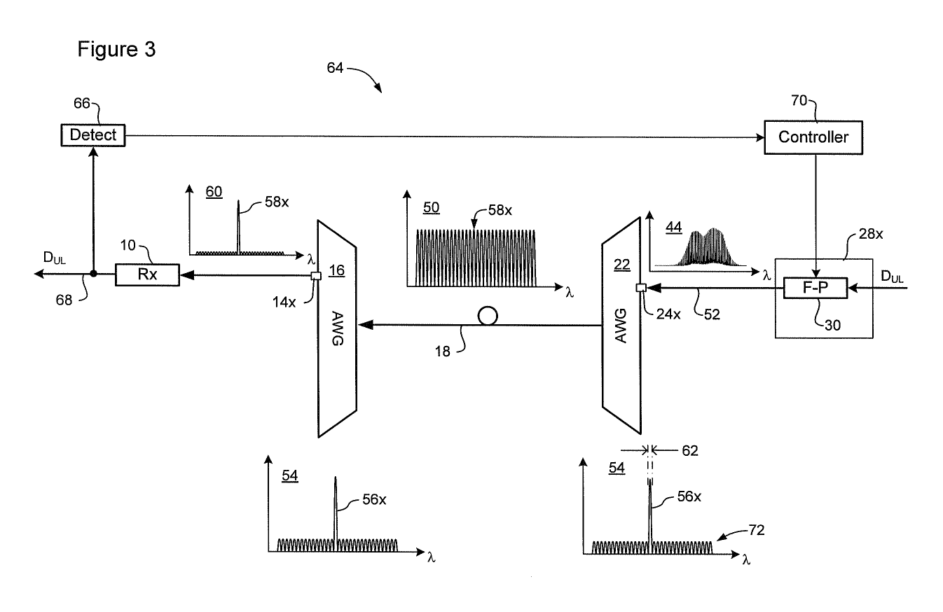

Referring to FIG. 3, a representative technique for utilizing non-injection seeded, directly modulated F-P lasers and AWGs to enable WDM-PON communications is schematically illustrated.

As may be seen in FIG. 3, in the uplink direction, uplink data D_{UL} from a given customer site (not shown) is supplied to the customer's ONT 28x (where “x” is an index), and used to drive a non-injection seeded F-P laser 30. The optical signal 52x output by the laser 30 is a broadband multimode optical signal having a spectrum 44 similar to that described above with reference to FIG. 2, and which is intensity modulated with the uplink data D_{UL}. This optical signal 52x is supplied to a respective branch 24x of the Remote node's AWG 22. The AWG 22 implements a band pass filter function 54 characterised by a pass-band 56x uniquely associated with the respective branch 24x, as described above. Consequently, the AWG 22 operates to couple a narrow band of wavelengths within the pass-band 56 from the branch port 24x to the trunk fibre 18. As may be seen in FIG. 3, this operation also has the effect of filtering the broadband signal 52 generated by the F-P laser 30 to produce a narrow uplink channel signal 58 which is Wavelength Division Multiplexed with uplink channel signals from other ONTs within the trunk fibre 18. In order to successfully convey uplink data D_{UL} to the OLT 4, the pass-band 50 of the AWG filter function 52 must be wide enough to encompass at least one mode of the broadband signal 46 generated by the F-P laser 30. In addition, it is important that each of the modes are sufficiently independent that attenuation of out-of-band modes by the AWG filter function 54 does not seriously degrade in-band modes that are coupled into the trunk fibre 18. Modern F-P lasers and AWGs can be designed and manufactured to satisfy both of these conditions.

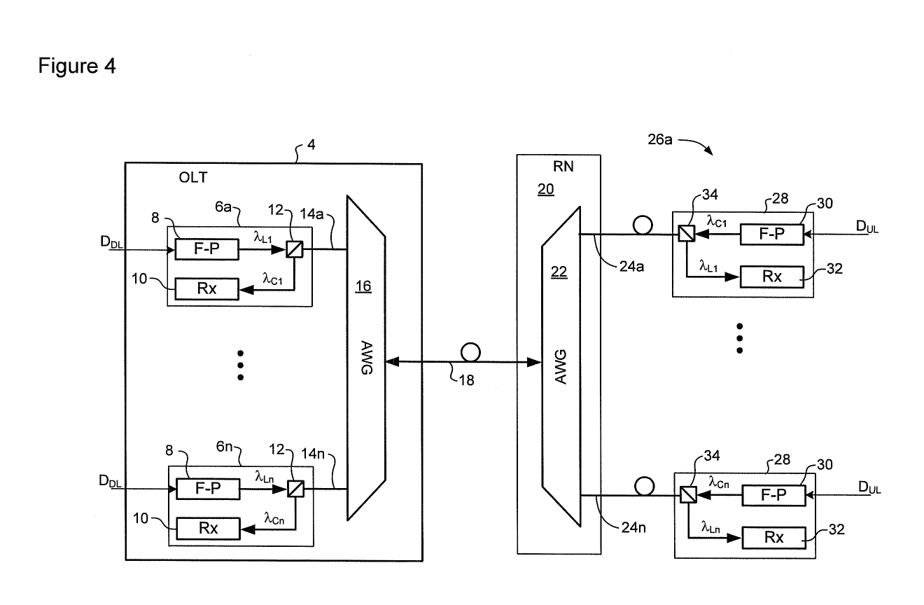

As shown in FIG. 4, the OLT AWG 16 implements a band pass filter function 54 closely matching that of the Remote node's AWG 22, and thus having a pass-band 56x uniquely associated with a respective branch 14x associated with the transmitting ONT 28x, as described above. Consequently, the AWG 16 demultiplexes the narrow uplink channel signal 58x from the trunk fibre 18, and the demultiplexed channel signal 58x is supplied to the receiver 10 for detection of the uplink data D_{UL}, all in a conventional manner. As may be appreciated, the spectrum 60 of the demultiplexed channel signal 58x input to the receiver 10 will be the product of the respective filter functions of both AWGs 22 and 16.

In order to successfully convey uplink data D_{UL} to the OLT 4, the pass-band 56x of the filter functions 54 implemented in both AWGs 16 and 22 must have a passband width 62 that is wide enough to encompass at least one mode of the broadband signal 44 generated by the F-P laser 30. In embodiments in which the AWG filter function pass-band width 62 are broad enough to encompass two or more modes 46, precise alignment between any given modes and the center wavelength of the pass-band 56 may not be essential. However, in some cases, it will be desirable to construct the AWGs 16 and 22 such that the pass-band 56 encompasses a single mode 46 of the F-P laser 30 output spectrum 44. In such cases, misalignment between the pass-band 56 and the modes 46 of the F-P laser 30 output spectrum 44 can significantly degrade performance of the WDM PON, and it is therefore desirable to implement a control loop to prevent any such drift. FIG. 3 illustrates a possible feedback control loop 64 for this purpose.

In the feedback control loop 64 of FIG. 4, a detector 66 monitors the recovered signal 68 output from the receiver 10 to detect one or more parameters indicative of the quality of the received channel signal 58. For example, the detector 52 may operate to detect any one or more of: a power level received channel signal 58; a bit error rate; or a FEC error rate. Other suitable signal quality parameters may equally be detected. Information indicative of the detected parameter (which may be a value of the parameter itself, or a value derived from it) is then sent to a control unit 70 of the F-P laser 30. In some embodiments, a control channel of the WDM-PON may be used for this purpose. Based on the information received from the detector 66, the control unit 70 can control the F-P laser 30 so as to optimize the quality of the of the channel signal 58 at the receiver 10. For example, the control unit 70 may operate to adjust the laser temperature and/or the drive current, both of can be used (alone or in combination) to adjust the laser output spectrum 44, and thereby ‘tune” the laser output for a given WDM PON channel by aligning a mode to the center wavelength of the AWG pass-band 56 corresponding to that channel.

In some embodiments, the laser 30 can be constructed such that the mode spacing in the laser output spectrum 44 corresponds with the channel spacing of the WDM-PON. In such cases, a one-to-one correspondence will exist between each mode 46 and each channel of the WDM PON.

In other embodiments, the laser 30 can be constructed such that the mode spacing in the laser output spectrum 44 differs from the channel spacing of the WDM-PON. For example, a laser cavity length of 400 um will yield an output spectrum 44 having approximately 30 modes within the frequency range of a channel band having 32 channels. In such cases, the feedback loop 64 described above can be used to tune the nearest mode 46 to any desired channel. However, once this has been done, it will be seen that the remaining modes 46 of the laser spectrum 44 will be misaligned with the other channels 58 of the WDM PON channel band. In some cases, this is advantageous, in that it reduces crosstalk between channels.

More particularly, referring back to FIG. 3, the band-pass filter function 54 implemented by the AWGs 16 and 22 comprises a pass band 56 corresponding to a specific channel of the WDM-PON, and a noise floor 72 which represents leakage of output-of-band light through the AWG. As such, the filtered channel signal 58x multiplexed into the trunk fibre 18 by the Remote Node's AWG 22 is accompanied by out-of-band light from each of the other modes of the laser output signal 52. However, in a case where the mode spacing corresponds with the channel spacing, these out-of-band modes are aligned with the filter pass-band(s) of the OLT AWG 16, and thus will be coupled into each OLT receiver 10, where it will appear as cross-talk in the received channel signal 60. On the other hand, by ensuring that the mode spacing does not correspond with the channel spacing, the out-of-band modes from channel 58x will not be aligned with the pass-band(s) of the OLT AWG 16, and thus will be attenuated.

An advantage of the embodiment of FIG. 3 is that effectively colorless operation of the ONTs 28 is enables without the use of seed light. As a result, the C-band SLS 40 and circulator 42 can be eliminated, thereby reducing cost of the OLT 4. If desired, the arrangement of FIG. 3 can be mirrored in the downlink direction, thereby enabling elimination of the L-Band SLS 36 and circulator 38, as may be seen in FIG. 4. Furthermore, the round-trip attenuation and data-transmission-rate impairments associated with conventional seed light injection systems of the type described above with reference to FIG. 1 are avoided. At high-speed line rates (for example of about 1 GHz and higher) the technique of the present invention offers a significant performance advantage over prior art systems.

As may be seen in FIGS. 2 and 3, the bandwidth of the multi-mode signal 44 generated by an F-P laser is typically broader than any one channel band 50 of the WDM PON. This is advantageous because all of the ONTs 28 can be provided with identical F-P lasers 30, and all of the OLT 4 transceivers 6 can be provided with identical F-P lasers 8, allowing economies of scale to reduce unit costs.

The embodiments of the invention described above are intended to be illustrative only. The scope of the invention is therefore intended to be limited solely by the scope of the appended claims.

We claim:

1. A Wavelength Division Multiplexed Passive Optical Network (WDM-PON) comprising:
a respective Optical Network Terminal (ONT) at each one of a plurality of customer sites, each ONT comprising an ONT Fabry Perot (F-P) laser for generating a respective broadband multi-mode uplink optical signal; and
an Array Waveguide Grating (AWG) for receiving each broadband multi-mode uplink optical signal through a respective branch port, and for multiplexing a portion of each received broadband multi-mode uplink optical signal into a Wavelength Division Multiplexed (WDM) signal;
wherein each ONT F-P laser is non-injection seeded;
wherein a gain of each ONT F-P laser is sufficiently inhomogeneous that the modes of the respective broadband multi-mode uplink optical signal are independent; and
wherein a filter function of the AWG includes a pass band that encompasses at least one mode of a broadband multi-mode uplink optical signal generated by the ONT F-P laser.

2. The system as claimed in claim 1, wherein each ONT F-P laser is directly driven by an uplink data signal, such that the respective broadband multi-mode uplink optical signal is intensity modulated with the uplink data signal.

3. The system as claimed in claim 1, further comprising a control unit for controlling at least one of a temperature and a drive current of the ONT F-P laser to optimize a quality of a respective optical channel signal at a first receiver of the WDM-PON.

4. The system as claimed in claim 1, wherein the pass band of the AWG encompasses a single mode of the broadband multi-mode uplink optical signal.

5. The system as claimed in claim 4, wherein a mode spacing of the broadband multi-mode uplink optical signal does not equal a channel spacing of an uplink channel band of the WDM-PON.

6. The system as claimed in claim 1, further comprising an Optical Line Terminal (OLT) comprising:
a respective transceiver associated with each ONT, each transceiver including a respective OLT Fabry Perot (F-P) laser for generating a corresponding broadband multi-mode downlink optical signal; and
an OLT Array Waveguide Grating (AWG) for receiving each broadband multi-mode downlink optical signal through a respective branch port, and for multiplexing a portion of each received broadband multi-mode downlink optical signal into a Wavelength Division Multiplexed (WDM) signal;
wherein each OLT F-P laser is non-injection locked;
wherein a gain of each OLT F-P laser is sufficiently inhomogeneous that the modes of the corresponding broadband multi-mode downlink optical signal are independent; and
wherein a filter function of the OLT AWG includes a pass band that encompasses at least one mode of a broadband multi-mode downlink optical signal generated by the OLT F-P laser.

7. The system as claimed in claim 6, wherein each OLT F-P laser is directly driven by an uplink data signal, such that the respective broadband multi-mode downlink optical signal is intensity modulated with the uplink data signal.

8. The system as claimed in claim 6, further comprising a control unit for controlling at least one of a temperature and a drive current of the OLT F-P laser to optimize a quality of a respective optical channel signal at a second receiver of the WDM-PON.

9. The system as claimed in claim 6, wherein the pass band of the OLT AWG encompasses a single mode of the broadband multi-mode downlink optical signal.

10. The system as claimed in claim 9, wherein a mode spacing of the broadband multi-mode downlink optical signal does not equal a channel spacing of a downlink channel band of the WDM-PON.
